(19) United States
(12) Patent Application Publication
(10) Pub. No.: US 2025/0346213 A1
(43) Pub. Date: Nov. 13, 2025

(54) VEHICLE ARCH SYSTEM WITH RELOCATABLE SEPARATOR

(71) Applicant: VACUUM TECHNOLOGIES, LLC, Sheridan, WY (US)

(72) Inventors: John F. Tucker, Sheridan, WY (US); Tylen Scott Redinger, Sheridan, WY (US); Daniel Scott Kerbs, Sheridan, WY (US); Justin Taylor Heaps, Ranchester, WY (US); Samuel Ward Cape, Sheridan, WY (US); Casey Donn Cash, Sheridan, WY (US)

(21) Appl. No.: 19/204,762

(22) Filed: May 12, 2025

Related U.S. Application Data
(60) Provisional application No. 63/645,951, filed on May 12, 2024.

(51) Int. Cl. B60S 3/00; B08B 5/04

(52) U.S. Cl. CPC B60S 3/008; B08B 5/04

(57) ABSTRACT

A vacuum arch system located at a vehicle treatment facility that provides suction to a vacuum hose used by a user at the vehicle treatment facility to clean an inside of a vehicle of the user. The vacuum arch system has a vertical support pole, an arch arm having a front end and a back end attached to the top of the vertical support pole, at least one vacuum hose, a right side rear bracket and a left side rear bracket, and a separator. The separator may be relocated to either the front end of the arch or the back end of the arch. On the front end, it is connected to the arch by a downwardly extending inlet pipe that hangs below the arch. On the back end, it is connected to the arch by an airflow pipe and the vacuum hose connects to the front end.

### CROSS-REFERENCE TO RELATED APPLICATION

This application claims priority to U.S. Provisional Ser. No. 63/645,951, filed on May 12, 2024, entitled “VEHICLE ARCH SYSTEM WITH RELOCATABLE CYCLONIC SEPARATOR”, the disclosure of which is incorporated by reference in its entirety.

### BACKGROUND

Car wash facilities often include vacuum systems that patrons of the car wash may use to vacuum inside of their vehicles. Individual canister vacuum systems located adjacent to the location where a vehicle may be vacuumed are sometimes employed. Also, systems are sometimes employed that use a central vacuum system providing vacuum forced air from a location remote from the vehicle location such as in a facility central building to the individual vehicle vacuuming bays. In such instances where the main vacuum supply motor of the facility is located in a central facility, the facility may sometimes employ a long main vacuum line to provide vacuum suction to numerous vacuuming locations at the facility. These systems generally employ a vacuum system with enough overall suction capacity to provide service to all of the vehicle vacuuming locations even though it is rare that all of the vehicle vacuuming locations are used simultaneously.

### SUMMARY

One aspect of the present disclosure is generally directed to a vacuum arch system that is typically located at an overall vehicle treatment facility. The vacuum arch system provides suction to a vacuum hose/conduit. The hose is used by a customer of the overall vehicle wash to clean/vacuum objects from an inside of a vehicle. The vacuum hose is engaged to a main vacuum line of the vehicle treatment facility. The vacuum arch system of the present disclosure typically includes a vertical support pole having a top end and a bottom end, where the bottom end is secured to the ground. It also typically includes an arch arm attached to the top end of, and extending from, the vertical support pole. The vertical support pole typically has a first end with a downwardly facing inlet pipe and an open second end proximate to the vertical support pole. The vacuum arch system also typically has a vacuum hose, a right side rear facing bracket, and a left side rear facing bracket. The right side rear facing bracket typically has a right side pole engaging portion and a right side grip bracket. It is typically engaged to the vertical support proximate to the top end by the right side pole engaging portion. The left side rear facing bracket typically has a left side pole engaging portion and a left side grip bracket. The left side rear facing bracket is typically engaged to the vertical support proximate to the top end by the left side pole engaging portion. The left side grip bracket and the right side grip bracket typically matingly engage and the right side rear facing bracket and the left side rear facing bracket typically together form an overall rear side bracket. The vacuum arch systems of the present disclosure typically have a separator is operably engaged to either the downwardly facing inlet pipe or the second end of the arch. When engaged to the downwardly facing inlet pipe, the second end of the arch is engaged with a main vacuum line via a tee junction and the separator is engaged with the at least one vacuum hose. The overall rear bracket supports the tee junction. When the separator is engaged to the second end, the downwardly facing inlet pipe is engaged with the at least one vacuum hose and the separator is an engaged to the main vacuum line. The overall rear side bracket supports the separator.

Another aspect of the present disclosure is generally directed to a vacuum arch system for providing suction to a vacuum hose. The vacuum arch system may have a front end separator configuration or a rear end separator configuration. In the front end separator configuration, the hose, which may be solid conduit, flexible conduit, or a combination thereof, is typically a flexible hose (at least the portion used by the customer) and is used by a customer of the overall vehicle wash to clean an inside of a vehicle. The vacuum hose is typically engaged to a main vacuum line of the vehicle treatment facility. The vacuum arch system typically includes a vertical support pole having a top end and a bottom end. The bottom end is typically secured to the ground or cement or other surface over the ground. The vacuum arch system also typically includes an arch arm attached to the top end of, and extending from, the vertical support pole. The vertical support pole typically has a first end with a downwardly facing inlet pipe, and an open second end proximate to the vertical support pole. The vacuum arch system also typically has a vacuum hose, a right side rear facing bracket, and a left side rear facing bracket. The right side rear facing bracket has a right side pole engaging portion and a right side grip bracket. It is engaged to the vertical support proximate to the top end by the right side pole engaging portion. The left side rear facing bracket has a left side pole engaging portion and a left side grip bracket. It is engaged to the vertical support proximate to the top end by the left side pole engaging portion. The left side grip bracket and the right side grip bracket typically matingly engage and the right side rear facing bracket and the left side rear facing bracket form an overall rear side bracket. The vacuum arch system typically has a separator engaged to the downwardly facing inlet pipe. The second end of the arch typically is engaged with a main vacuum line via a tee junction and the separator typically is engaged with the at least one vacuum hose. Typically, two vacuum hoses will be hung from the separator, but one may be used instead. Each vacuum hose may have a different suction providing nozzle tool such as a crevasse tool, brush head, or claw utility nozzle.

Yet another aspect of the present disclosure is generally directed to a vacuum arch system that is typically located adjacent a vehicle washing facility and associated therewith to form an overall vehicle treatment facility. The vacuum arch system provides suction to a vacuum airflow conduit system that may include solid piping or flexible hose portion(s) that together form the vacuum hoses of the present disclosure. The vacuum arch system may be positioned such that the separator is proximate a back end of the vacuum arch system in a back end separator configuration. Alternatively, the separator may be positioned in a front end separator configuration. The vacuum hose is typically engaged to a main vacuum line of the vehicle treatment facility. The vacuum arch system typically includes a vertical support pole having a top end and a bottom end. The bottom end is typically secured to the ground. It also includes an arch arm attached to the top end of, and extending from, the vertical support pole. The vertical support pole typically has a first end with a downwardly facing inlet pipe engaged thereto, and an open second end proximate to the vertical support pole. Alternatively, an external pipe or conduit or hose may be engaged with the support pole to allow vacuum airflow from one end of the support pole to the opposite end of the support pole or structure. The vacuum arch system also typically has a vacuum hose, a right side rear facing bracket, and a left side rear facing bracket. The right side rear facing bracket has a right side pole engaging portion and a right side grip bracket. The right side rear facing bracket is engaged to the vertical support proximate to the top end by the right side pole engaging portion. The left side rear facing bracket has a left side pole engaging portion and a left side grip bracket. The left side rear facing bracket is typically engaged to the vertical support proximate to the top end by the left side pole engaging portion. The left side grip bracket and the right side grip bracket typically matingly engage, but could be integrally formed or abut one another and the right side rear facing bracket and the left side rear facing bracket form an overall rear side bracket. The vacuum arch system typically employs a debris separator, but a debris separator may be omitted as well.

### BRIEF DESCRIPTION OF THE DRAWINGS

In the drawings:

FIG. 1A is perspective view of an exemplary car wash facility and its related vacuum system(s) and shows the building and vacuum systems where the main vacuum line is underground and not shown while nevertheless shared across each of the vacuum stalls/vehicle vacuuming locations.

FIG. 1B is a partial perspective view of a vacuum system(s) and stalls of an exemplary vacuum system of a car wash facility showing an aspect of the disclosure where the main vacuum line supplying vacuum to each of the individual stalls is above ground and extending between vehicle vacuuming locations along the pathway of the main vacuum line.

FIG. 2 is a front perspective view of a vacuum arch system with a debris separator, which may be a cyclonic debris separator, attached to the rear end of the arch according to an aspect of the present disclosure.

FIG. 3 is a rear perspective view of the vacuum arch system with the debris separator, typically a cyclonic debris separator, attached to the rear end of the arch according to an aspect of the present disclosure.

FIG. 4 is a side view of a vacuum arch system with the separator attached to the rearward facing end portion of the arch according to an aspect of the present disclosure.

FIG. 5 is a top view of a vacuum arch system with the separator attached to the rearward facing end portion of the arch according to an aspect of the present disclosure.

FIG. 6 is a front perspective view of a vacuum arch system with the debris separator, which may be a cyclonic debris separator, attached to the front end portion of the arch and wherein the debris separator is a dual connection cyclonic debris separator according to an aspect of the present disclosure.

FIG. 7 is a rear perspective view of a vacuum arch system with the cyclonic debris separator attached to the front end of the arch, a tee junction positioned proximate the rearward facing portion of the arch, and the separator is a dual connection cyclonic separator according to an aspect of the present disclosure.

FIG. 8 is a side view of a vacuum arch system with the separator attached to the front end of the arch, a tee junction positioned proximate the rearward facing portion of the arch, and the separator is a dual connection cyclonic debris separator according to an aspect of the present disclosure.

FIG. 9 is a top view of a vacuum arch system with the separator attached to the front end of the arch, a tee junction positioned proximate the rearward facing portion of the arch, and the separator is a dual connection cyclonic debris separator according to an aspect of the present disclosure.

FIG. 10A is a perspective view of an arch holding bracket, which supports and spaces the vacuum line above the arch support according to an aspect of the present disclosure.

FIG. 10B is an enlarged view of an arch holding bracket secured to an angled planar plate engaged to the top of the vertical support pole with the arch secured within the arch holding bracket and showing the arch supported above the base of the arch holding bracket according to an aspect of the present disclosure.

FIG. 11 is a front perspective view of left and right support brackets spaced apart and disengaged from one another according to an aspect of the present disclosure.

FIG. 12 is a side view of a right support bracket according to an aspect of the present disclosure.

FIG. 13 is a rear view of a left and right support brackets disengaged from one another according to an aspect of the present disclosure.

FIG. 14 is a close up view of a left and right support brackets engaged with one another while attached to the vertical support pole and engaged with a sanitary tee holding bracket according to an aspect of the present disclosure

FIG. 15 is a view of a sanitary tee holding bracket according to an aspect of the present disclosure.

FIG. 16 is a right side view of a sanitary tee holding bracket showing the upward curved surface to matingly engage the cylindrical exterior surface of the sanitary tee holding bracket according to an aspect of the present disclosure.

FIG. 17 is a close up view of the left and right support brackets while attached to the vertical support pole and holding up a separator according to an aspect of the present disclosure.

FIG. 18 is a perspective view of a separator holding bracket that may be used when the cyclonic debris separator is attached to the rear of the arch according to an aspect of the present disclosure.

FIG. 19 is a perspective view of a sanitary tee junction that attaches the vacuum arch system with the main vacuum line according to an aspect of the present disclosure.

FIG. 20A is an upper perspective view of a vacuum arch system with a debris separator attached to the rearward end portion of the arch and having an attached waste disposal bin, mat hanging rack, and vacuum hoses with differing nozzles/tools according to an aspect of the present disclosure.

FIG. 20B is an upper perspective view of a vacuum arch system with a debris separator attached to the front end of the arch and having an attached waste disposal bin, mat hanging rack, and vacuum hoses with differing nozzles/tools according to an aspect of the present disclosure.

### DETAILED DESCRIPTION

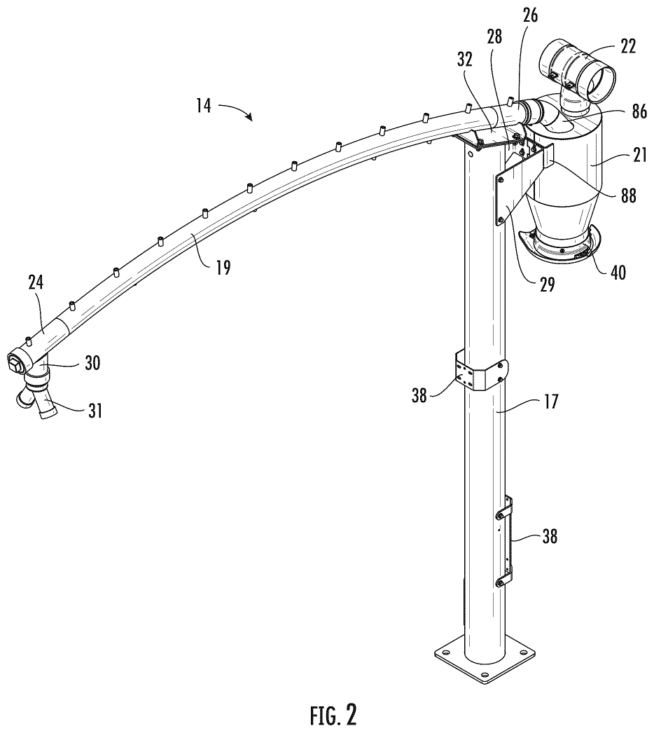

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “about” in the context of the present application means a range of values inclusive of the specified value that a person skilled in the art would reasonably consider to be comparable to the specified value. In certain aspects of the present disclosure, “about” means within a standard deviation using measurements generally accepted in the art. In other aspects of the present disclosure, “about” will mean the specified value but ranging up to ±10% of the specified value.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure and claimed invention, and further it is to be understood that such concepts are intended to be covered by the following claims unless these claims by their language expressly state otherwise.

It is to be understood that the disclosed innovations may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, 10) contained within the range. In this specification and the appended claims, the singular forms “a,” “an” and “the” include plural reference unless the context clearly dictates otherwise. All combinations of method steps or process steps as used herein can be performed in any order, unless otherwise specified or clearly implied to the contrary by the context in which the referenced combination is made.

To the extent that the terms “includes” or “including” or “have” or “having” are used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A” or “B” or both “A” and “B”. When the Applicant intends to indicate “only A or B but not both” then the term “only A or B but not both” or similar structure will be employed. Thus, use of the term “or” herein is the inclusive, and not the exclusive use. Also, to the extent that the terms “in” or “into” are used in the specification or the claims, it is intended to additionally mean “on” or “onto.” In this specification and the appended claims, the singular forms “a,” “an” and “the” include plural reference unless the context clearly dictates otherwise.

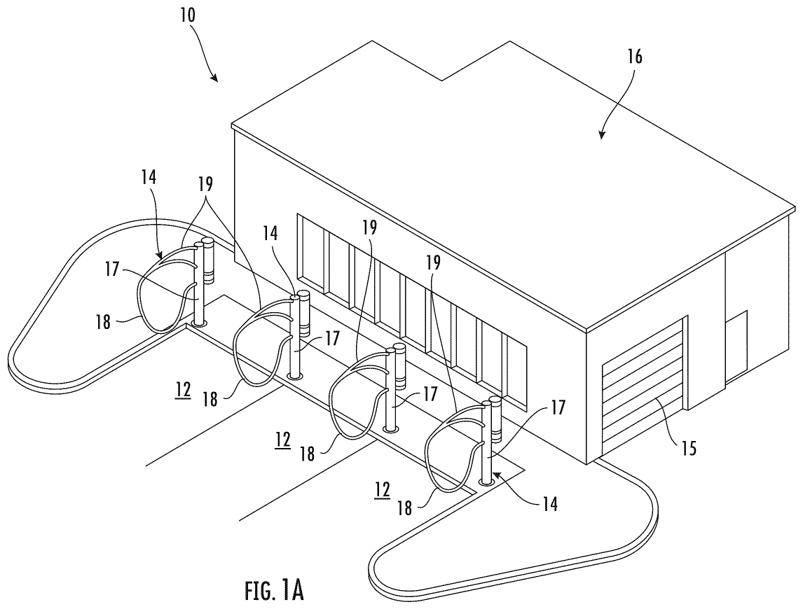

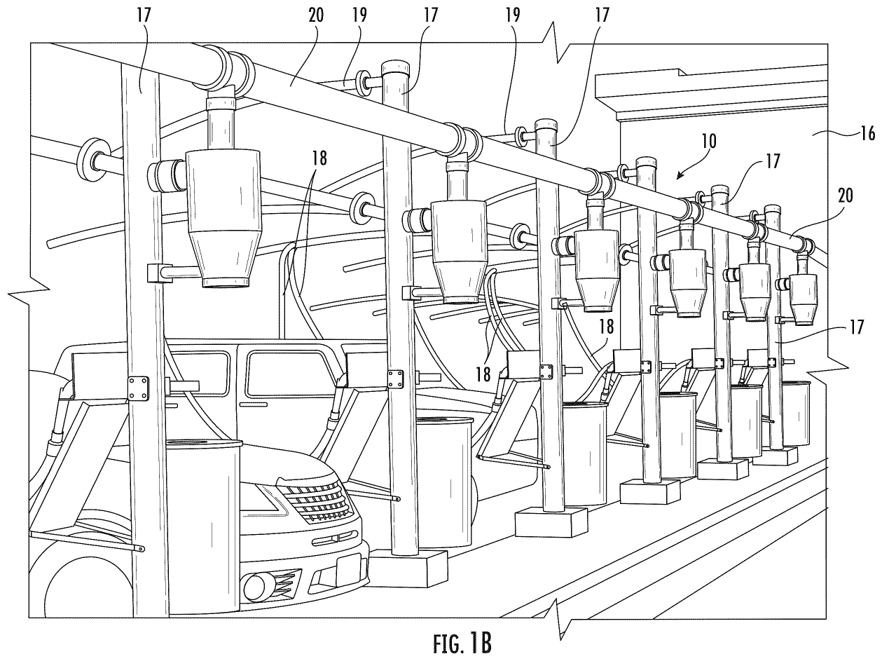

FIG. 1A generally displays an overall vehicle treatment facility 10 in which a vacuum arch system 14 of the present disclosure may be used to provide vacuum force/power to a plurality of locations simultaneously or one location as well if only one vacuum stall 12 is in use. The vacuum arch system 14 of the present disclosure is typically positioned outside of the main building 16 at the vehicle treatment facility. A vacuum motor assembly provides suction to the vacuum arch system 14 and is typically positioned in a portion of the main building 16 or a separate enclosure/building from the vehicle treatment facility such that it is separated from the washing portion of the facility but still enclosed and protected in order to protect it from weather and other environmental factors. A vacuum “arch” does not necessarily need to be curved, but could have a planar top portion that extends laterally away from the upright vertical support pole 17. The vacuum motor assemblies of the present disclosure provide vacuum force/power for each of at least one, but typically a plurality of, vacuum arch systems 14 that are each associated with at least one vacuum stall 12. A user of the vehicle treatment facility is able to park their vehicle in the vacuum stall 12, and use the vacuum arch system 14 to clean the inside of their vehicle.

The vacuum arch system 14 are each interconnected to a main vacuum line 20 that is operably engaged with the vacuum motor assembly. The vacuum arch systems 14 each typically include a vertical support pole 17, an arch 19, which again may or may not be arcuate and may be linear/planar. The arch typically extends from the top of or a top portion of the vertical support pole 17 above the vacuum stall 12. A user operates a vacuum line 18 that hangs down from or is otherwise engaged with the arch 19 such that a user can manipulate the user operated vacuum line 18 typically without it dragging across the ground. Each of the systems typically include a separator between the user operated vacuum line 18 and the main vacuum line to capture debris. The separator may be a cyclonic debris separator that captures debris using a cyclonic airflow. Each vacuum system's user operated vacuum line 18 attaches to a main vacuum line 20 either directly or indirectly through a separator 21 (See FIG. 1B), which is in turn, attached to a vacuum motor assembly, which provides vacuum power using a motor. In FIG. 1A, the user operated vacuum lines 18 and the main vacuum line 20 run underground, and are therefore not visible in the figure. The main vacuum line 20 can be located underground or above ground. In FIG. 1B, the main vacuum line 20 is positioned above the ground. Due to the amount of airflow that can be produced by the vacuum motor assembly, only a single unit needs to be used to run every vacuum system at the facility without the use of additional vacuum motor assemblies. The vacuum motor assembly will typically be sized to provide the necessary vacuum forces to effectively provide service to every stall of the overall vehicle treatment facility 10 even if each and every user operated vacuum line 18 is in use simultaneously. The main vacuum line, as well as other vacuum lines of the present disclosure, are typically hollow tubes that are typically made from a plastic polymer, but conceivably may be at least partially constructed of metal. The vacuum lines may be flexible or rigid, or rigid in some areas and flexible in others.

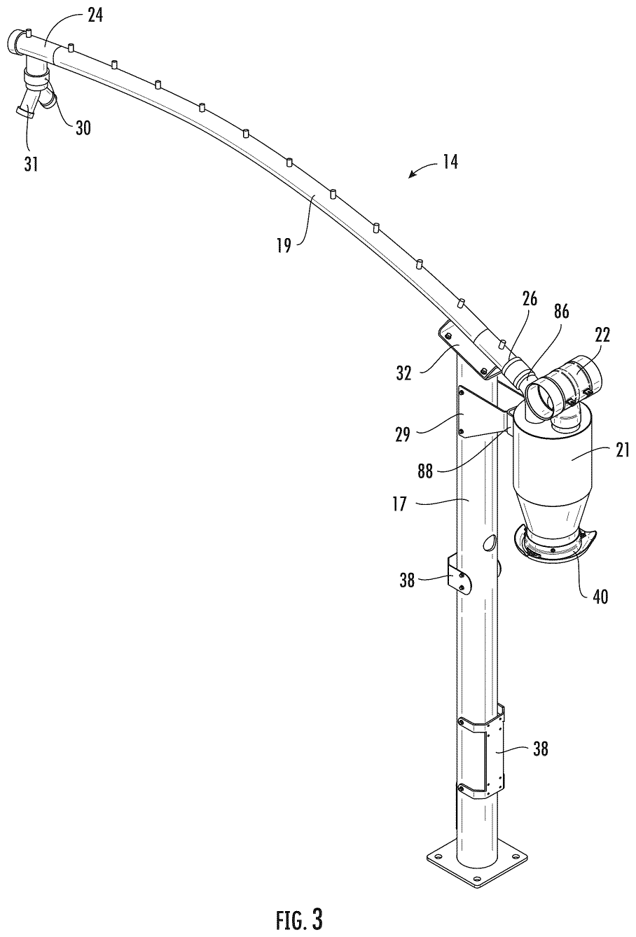

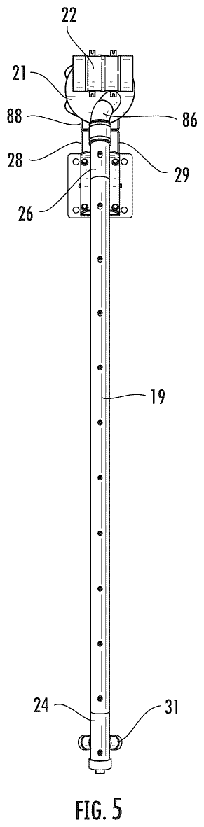

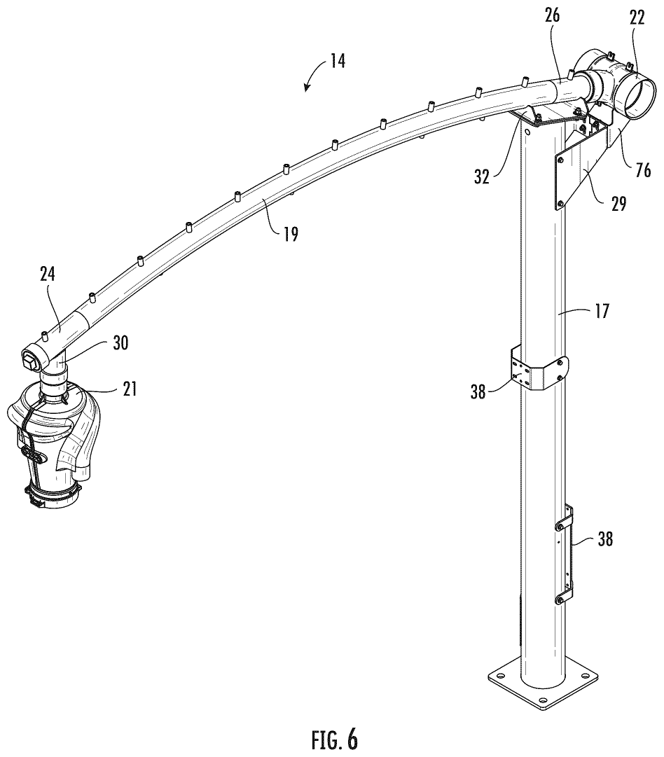

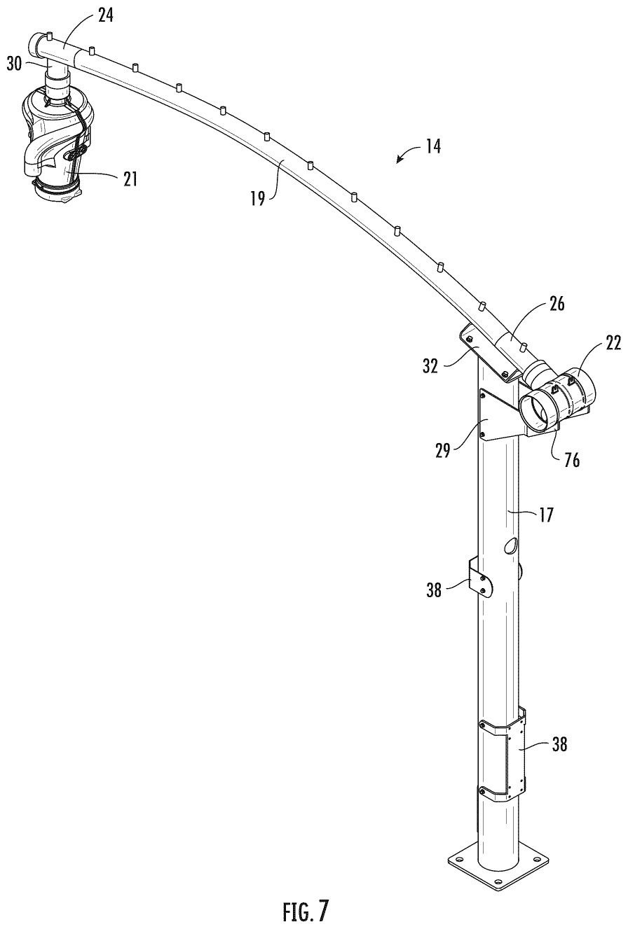

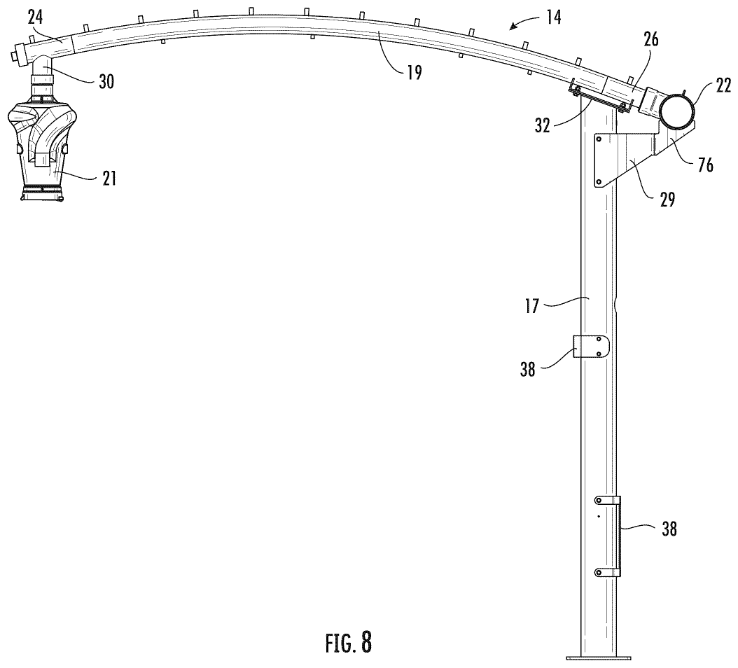

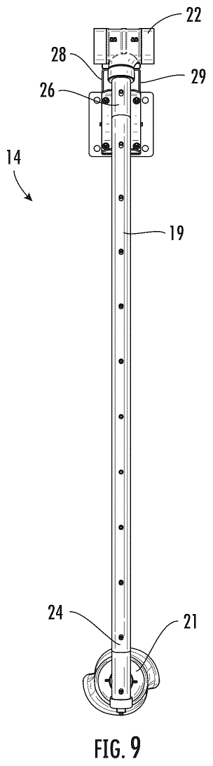

As shown in FIGS. 2-9 and discussed above, the vacuum arch system 14 includes a vertical support pole 17, an arch 19 that may be planar or arcuate and typically laterally extends from the top of the vertical support pole 17 above the vacuum stall 12, a sanitary tee junction 22 that connects the vacuum arch system 14 to the main vacuum line 20, and a separator 21 attached to an end of the arch 19. The arch 19 has a first end 24, which is distal from the vertical support pole 17, and a second end 26 with which is proximate to the vertical support pole 17. The debris separator, which is typically a cyclonic debris separator, may be attached proximate to either the first end 24 or the second end 26, the vacuum arch system 14 may be reconfigured to accommodate either position of the debris separator 21 depending on the needs of the users of the vehicle treatment facility and changed by the owner/operator of the facility as needed. The systems of the present disclosure provide greater configuration flexibility of the vacuum arch system. The systems are reconfigurable at any time after initial installation between configurations with the debris separator proximate opposite ends of the “arch”. The vehicle arch system further typically includes a left support bracket 28 and a right support bracket 29 fixed to the vertical support pole 17. The left and right support brackets 28, 29 enable a connection with either a sanitary tee or a separator 21 depending on the configuration of the vacuum arch system 14. The left and right support brackets 28, 29 are typically used in either configuration, allowing operators of the vehicle wash to easily swap the separator 21 between the front or back of the system according to their particular needs or vehicle treatment facility set up. Conceivably, the left and right support brackets may be formed into a unitary bracket, but this is not typically the case as discussed herein.

Because of the left and right support brackets, an overall vehicle treatment facility may easily use the vacuum arch system in either the front separator or rear separator configuration without exchanging large numbers of parts or engagement and disengagement of large amounts of components. The vertical support pole 17, the arch 19, arch holding/supporting bracket 32, and the left and right support brackets do not need to be changed or moved in any way during or for a reconfiguration. The core components of the vacuum arch system do not need to be modified, which translates to more freedom for overall vacuum facility to customize the vacuum arch system and cost reduction for a manufacturer who does not need to design and produce as many components. The downwards facing pipe can interchangeably mate with the separator discharge pipe or any other attachable vacuum line or junction. Likewise, the second end of the arch may easily be adapted to connect directly to the main vacuum line as well as the separator.

The vacuum arch system 14 is most typically made out of stainless steel or other metal. When using stainless steel, it is preferable to use tapping screws when attaching components to the arch 19 or the vertical support pole 17. The left and right support brackets 28, 29 may be attached with tapping screws for example. Tapping screws are easier to install, are cheaper, and therefore are typically used. If a user wishes to have welded components, they will either need to weld the parts on site or prior to shipping the whole system. Welding prior to shipping would mean that the shipped parts are larger, and thus, more difficult to ship. Alternatively, the vacuum arch system may be primarily, or entirely, composed of carbon steel. When using carbon steel, it is preferable to weld the additional components to the arch 19 and vertical support pole 17. Carbon steel may be too strong to easily use tapping screws. Stainless steel is preferable has it is sturdy while also providing vacuum treatment facility operators the flexibility to attach brackets and other components anywhere on the vacuum arch system they desire without needing to do any welding.

The arch 19 is typically at least partially hollow, with an internal suction providing airflow line that passes from the first end 24 of the arch 19 to the second end 26. However, the arch 19 could conceivably be a solid I-beam construction on both the upper support and the extending arch. In any case, the suction airflow can be provided partly or whole through a hose or other hard or flexible conduit that is affixed to or associated with the arch. The arch 19 typically has a slightly curved shape but could be flat/level/planar extending laterally from the vertical support pole top portion. The arch 19 has an opening at its second end 26 that allows the air to flow back into the main vacuum line 20 through the sanitary tee junction 22, as well as the separator 21 if the vacuum arch system 14 is configured to have a debris separator 21, typically a cyclonic debris separator, in the rear. There may be an opening at the front end. In this case, a cap may be put over the first end 24. A downwards facing pipe 30 is attached to the arch 19 near its first end 24. The downwards facing pipe 30 typically has a threaded opening, which allows other components to be screwed to it or a threaded aperture that receives other threaded components. Depending on the configuration of the vacuum arch system 14, a Y-shaped junction 31 or the separator 21 may be screwed onto and into engagement with the downwards facing pipe 30.

The arch may further include a series of studs along both the uppermost points of the arch and/or the lowermost points of the arch. The studs on top of the arch may be used to attach an awning or canopy or conceivably solar cell panels to the arch. The awning or canopy or conceivably solar cell panels may be suspended over the top of multiple arches 19, or it may be isolated to a single arch 19. The studs on the bottom of the arch 19 may be used to attach a light source or a plurality of light sources. The light source may be a light emitting diode (LED) light source or LED light strip, and which may also be a LED bar that is elongated in the direction of the arch 19. The light source may be battery powered or it may be supplied power from the overall vehicle treatment facility from a utility or solar power source. The light source provides illumination so that customers may be able to use the vacuum arch system 14 even when it is dark, allowing more freedom with what part of the day the vacuum arch system 14 is used.

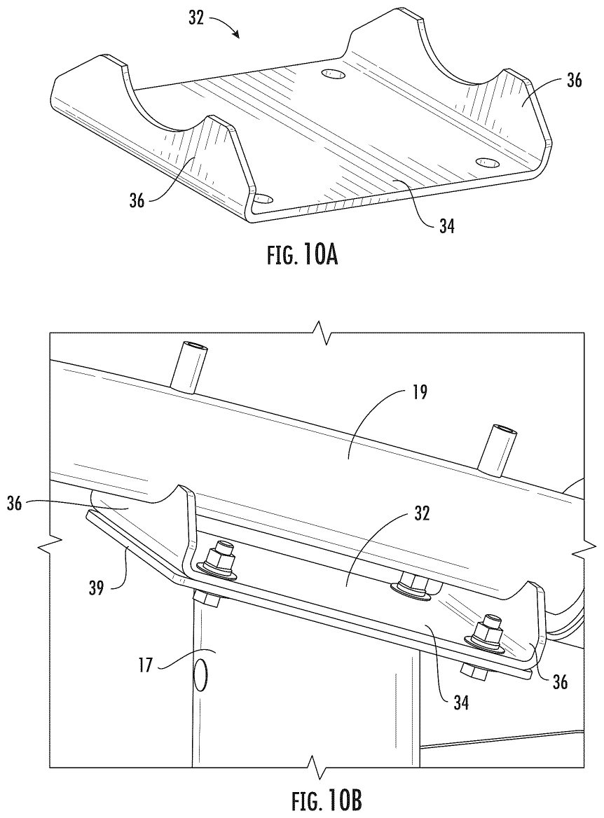

The arch holding bracket 32 of the vehicle arch system, as shown in FIGS. 10A-B, connects the arch 19 to the vertical support pole 17. It typically holds the arch 19 at an elevated angle relative to the ground. The holding angle combined with the shape of the arch 19 causes the arch 19 to “swoop” over the vacuum stall 12. The arch holding bracket 32 also spaces the arch above the base of the bracket. A position on the arch 19 between the first end 24 and the second end 26 becomes the high point above the ground, with the first end 24 being below or slight below that point height wise. To accommodate the angled position of the arch holding bracket 32, the vertical support pole 17 has a top portion end that has been cut at a matching angle relative to the ground and has a flat bracket support welded with the top portion to more easily allow for the engagement of the arch holding bracket.

The arch holding bracket 32 (FIGS. 10A-B) typically has a flat base 34, which typically is rectangularly shaped with four perimeter edges. The arch holding bracket 32 also includes two arch holding grips 36. One arch holding grip 36 is positioned on a first edge of the arch holding bracket 32, and another is positioned on a second edge of the arch holding bracket 32. The edges having the arch holding grips 36 are opposite to one another so that they are as spread out at they can be on the flat base 34. This ensures that the arch holding bracket 32 is providing support for the arch 19. If the arch holding brackets were positioned closer, they may not be able to provide the same balanced support and the arch 19 may break off of the brackets and tip up or down, or conceivable even fall of completely. The arch holding grips 36 have a generally triangular shape, save for an arch resting rim, which is typically sized to matingly engage a downward facing surface of the arch 19 and also extend upward along each side of the arch when the arch is a round or oval shaped conduit. The arch holding grips are typically located where the uppermost point of the triangular shape would be in an unaltered configuration. As discussed above, the arch resting rim typically defines a semi-circular cut within the arch grips. The arch 19 may be positioned in the arch holding grip, and the entirety of the arch resting rim contacts the outer surface of the arch 19. The fit of the arch 19 within the arch holding grips 36 typically provides some support against lateral movement of the arch 19 to both the right and left sides of the arch 19. The arch 19 is typically secured to the arch holding bracket 32 via a welded connection, or it may be attached by fasteners such as tapping screws, self-tapping screws, or bolts. The connection is usually such that the arch is not removable by hand and without the use of tools.

A flat bracket support 39 (FIG. 10B) may be positioned on the top end of the vertical support pole 17, which may have an angled or flat (at least substantially parallel to the surface of the vacuum stall) top plate affixed thereto, typically by a weld. The top plate typically has four spaced apart apertures that are in each corner of the plate when it is rectangular. The flat bracket support 39 is typically engaged/fixed to the vertical support pole 17, possibly by a welded connection, or by fasteners. The fasteners may be tapping screws, similar to the tapping screws that other components of the vacuum arch system 14 are secured with, or nuts and bolts with optional washers that pass through both the flat bracket support 39 and the top plate as shown in FIG. 10B. Tapping screws enable the flat bracket support 39 to be connected to the vertical support pole 17 with less expense. The bracket support is typically rectangular, and may substantially match the shape of the flat base 34 of the arch holding bracket 32. The flat bracket support 39 typically has a smooth surface to contact an underside surface of the flat base 34, and both the flat bracket and the flat base 34 do not have any space between them when affixed to one another. Again, a plurality of through holes are typically spaced evenly across the flat bracket support 39. These through holes correspond to identically sized, or near identically sized, through holes in the flat base 34. A fastener may be passed through the through holes on the flat bracket support 39 and through the corresponding through holes in the flat base 34. Typically, the flat bracket support is held an angle of about 15° to about 25° relative to the ground/surface of the vehicle vacuuming stall. The angle is more preferably about 20° relative to the ground. Alternatively, the flat bracket may not be present at all. In some embodiments of the present disclosure, the arch holding bracket 32 may be attached directly to the vertical support pole 17 top end via its flat base 34. This attachment is typically a welded attachment as well.

The flat bracket support allows the operators of a vehicle treatment facility to easily connect the arch to the vertical support pole. In other similar arch systems, the arch may integral with the vertical support pole 17. This means that the arch system has to be shipped as a single device, which is far more expensive than shipping the arch 19 and the vertical support pole separately. Also, when assembling, the assembler does not need to weld the arch to the vertical support pole. They only need to bolt the arch holding bracket 32 of the arch 19 to the flat bracket support 39. This is far less expensive and time consuming than welding. Because of the relatively low angle of about 20 degrees, it is easier for an assembler to line up the arch holding bracket and the flat bracket support than if the angle were much higher. In previous designs, the angle may have been up to 50 degrees, which is still possible in the case of the present disclosure, but not typical. The flat bracket is typically at an angle that is closer to the horizontal than the vertical to make it easier to support the arch while it is being lined up and bolted to the vertical support pole 17. It is also easier to attach the arch to the arch holding bracket as compared with other designs. A user only needs to weld along the two arch resting rims in the arch grips. In designs were the arch directly contacts the vertical support pole, an assembler typically would need to weld everywhere along the connection of the pole to the arch. Welding is typically done along longer lengths of the arch surface in such a case. If an arch of the present disclosure in any configuration is ever damaged, but the vertical support pole 17 is still useable, than the arch may be easily removed and replaced with a new arch 19 due to the use of a plurality of fasteners to hold the arch holding bracket 32 to the flat base 39 without having to replace the vertical support pole. This is typically easier when the arch holding bracket is used.

The user operated vacuum lines have one end that connects directly or indirectly to the suction providing vacuum line and a second end that typically ultimately terminates in a nozzle 104, that typically employs a suction tool. The suction tool may be a narrow crevice tool that can reach into tight spaces within a vehicle. Alternatively, the nozzle 104 may instead be a claw tool having a wide, elongated opening that a user may use to vacuum wise sweeps of the interior of the vehicle. The vacuum arch system 14 may include a nozzle support bracket 106. The nozzle support bracket is connected to the vertical support pole 17 via a pole bracket 38. The pole bracket 38 is most preferably secured to the vertical pole by tapping screws. Using tapping screws makes the vacuum arch system 14 easier and cheaper to assemble or disassemble. The nozzle support bracket includes a nozzle holder 108 for each user operated vacuum line at the vacuum arch system 14 that a customer or user may place the nozzle into when the vacuum arch system 14 is not in use. Each nozzle holder is differently shaped to accommodate the different suction tools that may be present. The user operated vacuum line 18 is entirely suspended off of the ground, being secured at one end by the arch 19 and by the nozzle end at the user operated vacuum line 18 nozzle support.

The vacuum arch system may, in some embodiments, have a mat rack 98 for holding up floormats from a user's vehicle. The floor mats are typically removed from the vehicle so that the user may vacuum the space underneath them and well has more easily clean the mats themselves. The mat racks 98 typically have a substantially flat apertured surface that a user may lay the mat on during vacuuming. The mat racks may also be set at an incline for ease of use. A hook 100 may be present on the mat rack to further secure the mat on the mat rack and prevent it from sliding off onto the ground. The mat rack is typically about 12.5 inches to about 17.5 inches wide, more typically about 17 inches or about 13 inches wide. The mat rack is also about 26.5 to about 27.5 inches long, more typically about 27 inches long. The mat rack is secured to the vertical support pole with fasteners such as tapping screws, or may be connected indirectly through a pole bracket.

The vacuum arch system may also have an air compressor that a user may use to blow out debris from portions of their car that may not be easily reached by the user operated vacuum lines. Compressed air may be provided by one or more small compressed air lines that are attached to the vertical support pole. The air compressor may be located inside the pole or may be delivered to the vertical support pole by an external air pump. The compressed air lines may have a compressed air nozzle that is user handled and user activated. The compressed air nozzle may have a handle that allows the user to easily grip the compressed air line. A compressed air hanger 102 is attached to the vertical support pole proximate to the compressed air lines and allows a user to hang the handle off of it so that the compressed air lines are held above the ground.

The vacuum arch system of the present disclosure makes use of a separator to catch debris before the debris enters the main vacuum line. The separator typically will have at least one air inlet and at least one air discharge pipe. A holding space for debris is positioned below the air discharge pipe so that debris falls into the holding space when it is prevented from escaping in the air discharge pipe. The air enters the separator through the air inlet, and carries any debris sucked in from a user's vehicle. Air is allowed to leave through the air discharge pipe but large/heavy enough debris will be caught within the separator. If the separator is engaged to the first end of the arch 19, then it may be attached directly to the user operated vacuuming lines that a user uses to clean the interior of their vehicle. One user operated vacuuming line will be attached to each air inlet. The air discharge pipe is engaged to the main vacuum line or the downwardly facing inlet pipe depending on the configuration of the vacuum arch system 14. In one embodiment of the disclosure, the separator is a filter separator. In the filter separator, the debris are stopped by a grate, baffle plate, screen, or another perforated surface that allows air to flow through it but not larger particles. Air and debris will enter the air inlet, and the air passes through the filter while the debris particles are caught and then fall into the debris holder. The debris will need to be removed from the separator before it builds up too much and clogs the air inlet or air discharge pipe. Typically, the separator includes a valve on the bottom of the debris holder that many be opened by hand or without the use of tools by a user to operator of the overall vehicle treatment facility. Once the debris is removed, it is sent to a waste container such as a trach can. The cyclonic debris separator is a device used to capture debris sucked into the vacuum system and prevent them from entering the main vacuum lines and potentially clogging them. They also prevent the debris from reaching the motor and damaging it. The cyclonic debris separator includes a cylindrical or conical container. High speed rotating airflow is established within a cylindrical or conical container. The high-speed rotating air is typically called a cyclone. Air flows in a helical pattern beginning at the top (typically the wide end) of the cyclone and ending at the bottom before exiting the cyclone in a straight stream through the center of the cyclone and out of an air discharge pipe, which may be located on the top of the cyclonic separator. Denser particles will not be able to follow the tight curves of the cyclone due to their inertia, and thus they hit the outside wall of the separator and fall to the bottom. The collected debris at the bottom of the separator can be removed by opening a single-hand openable dump valve assembly 40.

In one embodiment of the present disclosure, the cyclonic debris separator that may be used is that shown in U.S. Pat. No. 11,358,156, entitled “DUAL CONNECTION CYCLONIC OVERHEAD SEPARATOR,” which issued on Jun. 14, 2022, the entire disclosure of which is hereby incorporated by reference. Any debris separator may be employed in the context of the present disclosure, however. The cyclonic separator of the present disclosure may be constructed of two injected molded portions that form a first side and a second side, an air discharge pipe assembly and a single-hand openable dump valve. The sides matingly engage one another to form a central body portion of the cyclonic separator. The sides are typically held together by a series of fasteners such as screws, but could conceivably be glued or otherwise held together with an adhesive. The body of the cyclonic separator engages the single-hand openable dump valve assembly 40 and the air discharge pipe assembly. The first side and second side matingly engage one another and form two tool holder mounts on the front and back of the system as well as a collar. The collar is reinforced with reinforcing supports around the circumference of the collar, which like the rest of the central body portion are typically injection molded. The first and second side also employ first downward facing inlet and second downward facing inlet respectively. The two inlets each separately initially proceed in a vertical direction up the body of the vacuum separator and bend around in a generally L-shaped fashion around the circumference of the cyclonic separator such that air entering the inlets enters the interior cavity of the cyclonic separator at two different locations such that the air travels within the interior of the cyclonic separator to form a cyclone of air/gas within the interior of the body. At the entrance point to the interior of the body the air is traveling in a substantially horizontal direction to form the cyclone or vortex of air in the interior of the system. The first downward facing inlet and second downward facing inlet each have a generally circular engagement portion, which may be threaded to engage corresponding threads on the end of the user operated vacuum lines 18 used by the user. As air enters the system through the inlet the air and debris are immediately within the interior cavity of the separator. Because there are two inlets, a user operated vacuum line 18 may be attached to both, allowing a single vacuum arch system 14 to supply suction to two adjacent stalls. A dual connection cyclonic separator is not needed in a rear separator configuration and thus is preferred in only the front separator configuration.

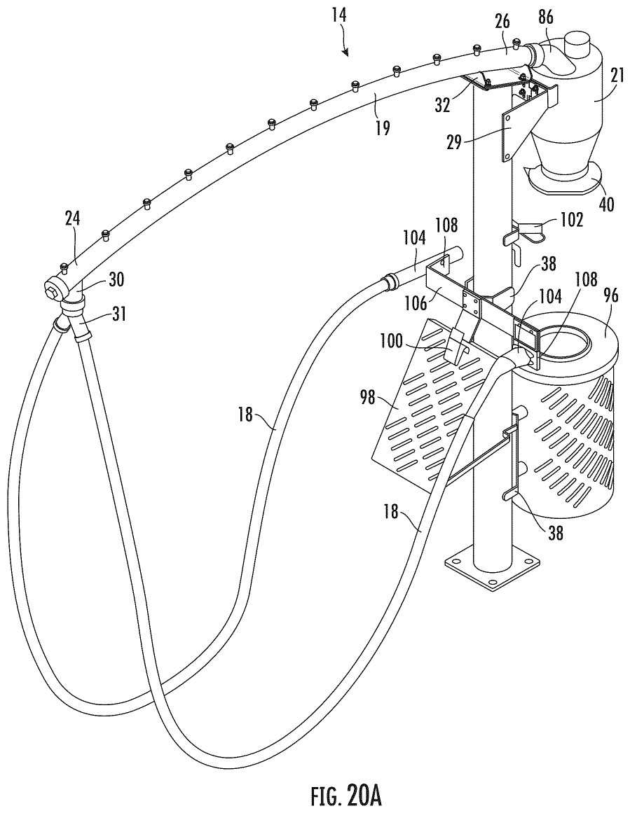

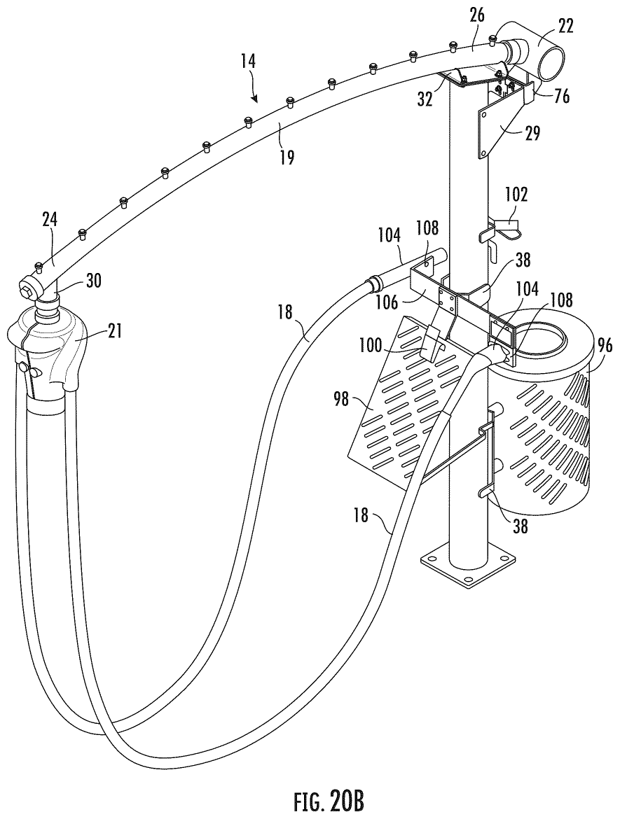

A waste container 96, as seen in FIG. 20A-B, may be located near the vacuum arch system 14 so that a user or facility operator may clean debris from the separator and place it in the waste container. The user simply opens the dump valve of the separator in order to release the debris. They may collect the debris in an intermediate holding container, such as a waste bag, in order to carry the debris collectively to the waste container. The waste container is typically a cylindrical, hollow container with an open top for accepting debris and other trash. The waste container may come with a lid that is attached to the container via a hinge, or the lid may be a separate piece that merely rest over the top of the waste container. In some embodiments, the waste container is attached to the vertical support pole by means of one or more pole brackets. The pole brackets 38 may be attached to the waste container and the vertical support pole by tapping screws or other similar fasteners. The waste container may also be a container that is nested within a waste container holding shell. The waste container holding shell may be secured to the vertical support pole and have a hollow cavity that the waste container can fit inside while still allowing a user to remove the waste container. The waste container typically has a volume of about 25 gallons to about 60 gallons. Most typically the volume of the waste container is about 30 gallons or about 55 gallons.

The separator 21, whether it is a cyclonic separator or another type of separator, may be attached to the vacuum arch system at a variable height above the ground. The downwards facing pipe may be different lengths in order to have the separator or Y-junction held at different heights to fit the needs of the vehicle treatment facility. Likewise, the airflow connection pipe 86 at the second end of the arch 19 may extend down further depending on where along the vertical support pole the separator is located. A waste container can be placed directly below, nearly directly below the separator. Because of this, a user who is clearing the separator will be able to move the debris from the separator to the waste container with minimal effort. Depending on the height of the separator above the open top of the waste container, the user may only need to open the dump valve and let the debris fall into the waste container by the force of gravity alone. This is typical if the separator attached to the second end of the arch 19. If the waste container is positioned below the separator attached to the front end, then the waste container would be overlapping the vacuum stall and potentially get in the way of a user's vehicle.

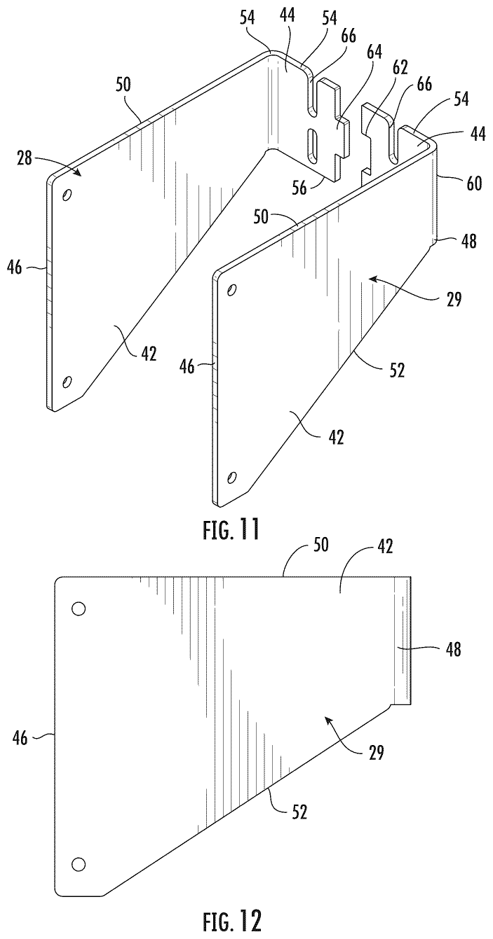

The systems of the present disclosure typically use a support bracket that may be unitary in construction, but more typically consists of left and right support brackets 28, 29 that are attached to the vertical support pole 17 typically proximate the top end (FIGS. 11-14). The left and right support brackets 28, 29 are similar to one another in shape and typically matingly engage with one another via a male and female construction with a cutout and mating projection on opposite sides of the support brackets. As mentioned above, the left and right support brackets 28, 29 could instead be a single unitary support bracket with no disconnect between the right and left support brackets 28, 29. However, two separate brackets are easier to transport, because they can be broken apart and be better condensed within packaging, and therefore more typically used. Each bracket almost mirrors the other, aside from the bracket locking slot and extension 62, 64. As such, one bracket may be oriented so that it fits into the other, and significantly saving on storage space. Both the right support bracket 29 and the left support bracket 28 include a pole engaging portion 42 and a grip bracket 44. The pole engaging portion 42 is typically trapezoidal-shaped, although it may have other shapes, such as square or rectangular. A trapezoidal pole engaging portion 42 has two parallel vertical edges, with a first vertical edge 46 being longer than a second vertical edge 48, a horizontal top edge 50, and an angled bottom edge 52. The vertical edges extend downward from the horizontal top edge 50. The angled bottom edge 52 connects the bottom ends of the vertical edges, which are typically not level with one another. The first vertical edge 46, or the longer vertical edge, is engaged with the vertical support pole 17. One or more through holes are located along the first vertical edge 46 on the pole engaging portion 42. Fasteners, such as punch in screws, attach the left and right support brackets 28, 29 to the vertical support pole 17 through the through holes. The pole engaging portion 42 may instead be welded or connected to the vertical support pole 17 by adhesives. The first vertical edge 46 of the right support bracket 29 is attached to the vertical support pole 17 at a point opposite to the point to which the first vertical edge 46 of the left support bracket 28. In effect, the rear facing brackets are completely across the vertical support pole 17 from one another. The pole engaging portions are tangential to the vertical support pole 17, are generally kept at a distance equal to the diameter of the vertical support pole 17 from one another.

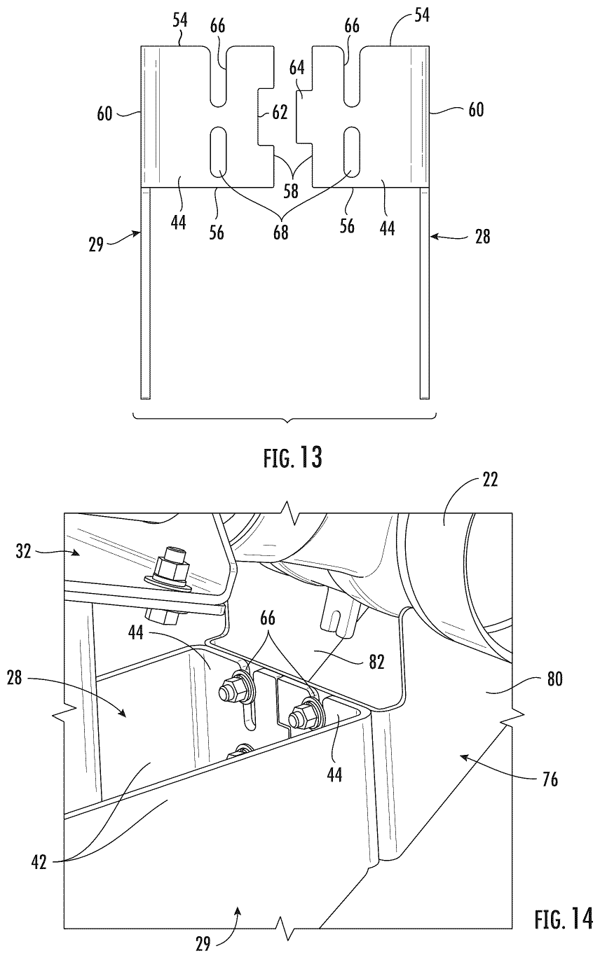

The grip brackets 44 of the rear facing brackets are connected to the pole engaging portions along the second vertical edge 48, and are typically set at a right angle with the pole engaging portions. Each grip bracket 44 typically has a top edge 54, a bottom edge 56, a bracket mating edge 58, and a pole engaging portion engaging edge 60. One grip bracket 44, typically the grip bracket 44 on the right support bracket 29, has a bracket locking slot 62 on its bracket engaging edge. The other grip bracket 44, typically the grip bracket 44 on the left support bracket 28, has a bracket locking extension 64 that matingly fits within the slot of the corresponding grip bracket 44. The bracket locking extension 64 matingly engages the right support bracket 29 to the left support bracket 28, and prevents vertical motion relative to one another. Once the rear side brackets are engaged, they act as a single bracket, and mutually provide support for components mounted to the vacuum arch system 14. The grip brackets 44 may also have one or more fastener slots. The slots have a length that is greater than their width. They are oriented with their long side vertical so that there is more freedom for a fastener to be moved up and down. The width of the slot is at least the width of the fasteners intended to be used to couple the brackets to the other mounted components. The slots allow for little to no side-to-side movement of the fasteners. The fastener slots cut through the grip bracket 44 from one surface to the opposite surface, and a fastener can pass through it and engage with another component. The fasteners used on the right and left support brackets 28 have a fastener head that is wider than the width of the slot. The fastener can pass through the slot from one surface until the head of the fastener contacts the surface of the grip bracket 44. In an aspect of the present disclosure shown in FIGS. 11 and 13, the fastener slots include an upper slot 66 and a lower slot 68. The upper slot 66 begins at the top edge 54 and extends downward. The top of the upper slot 66 is open, and a fastener can be slid into the slot as opposed to inserted into it. The lower slot 68 is disposed below the upper slot 66, but does not connect to the upper slot 66. The lower slot 68 does not connect to the bottom edge 56. The distance between the upper slot 66 and the lower slot 68 is sufficient enough to avoid the creation of a weak area with reduced thickness in the grip bracket 44.

The sanitary tee junction 22 may be used to attach the vacuum arch system 14 to the main vacuum line 20 of the overall vehicle treatment facility 10. The sanitary tee junction 22 has a first end 24 or upstream end 70, a second end 72 or downstream end and a third end or filter end 74. The first and second ends extend from opposite ends of a main body portion along the same axis. The first and second ends are configured and sized to connect to segment ends of the main vacuum line 20 and may form part of the overall main vacuum line 20. The inner diameter of the upstream end 70 is substantially the same as the outer diameter of the segment end of the main vacuum line 20. This allows for the segment ends of the main vacuum line 20 to fit within the first and second ends of the sanitary tee. Typically, the main vacuum line 20 fits into the first and second ends on a line-to-line fit, but a slight interference fit is acceptable as well. Because the sanitary tee has both an upstream and downstream end, a series of vacuum arch systems 14 may be set up near one another with the main vacuum line 20 passing between them and simultaneously delivering suction to each one. The overall vehicle treatment facility 10 may have as many vacuum arch systems 14 as desired for their particular needs/situation, and each is fed by the same main vacuum line 20. Only a single motor is needed to attach to the main vacuum line 20. The sanitary tee is preferably used an orientation where the first end 24 and the second end 26 are horizontal in order align with the main vacuum line 20. The horizontal orientation makes it so the air has a more direct airflow path to the vacuum motor with less turns. If the first end 24 and second end 26 were vertical, there would need to be another junction connection to attach to the main vacuum line 20, which is generally horizontal. The more twists and turns there are, the weaker the airflow becomes, which is suboptimal. Additionally, increased friction will build up heat within the main vacuum line 20. If the heat is raised enough, it may damage the main vacuum line 20 or other components of the overall vehicle treatment facility 10 such as the motor. In some situations, the motor may overheat from hot air and melt or otherwise deform.

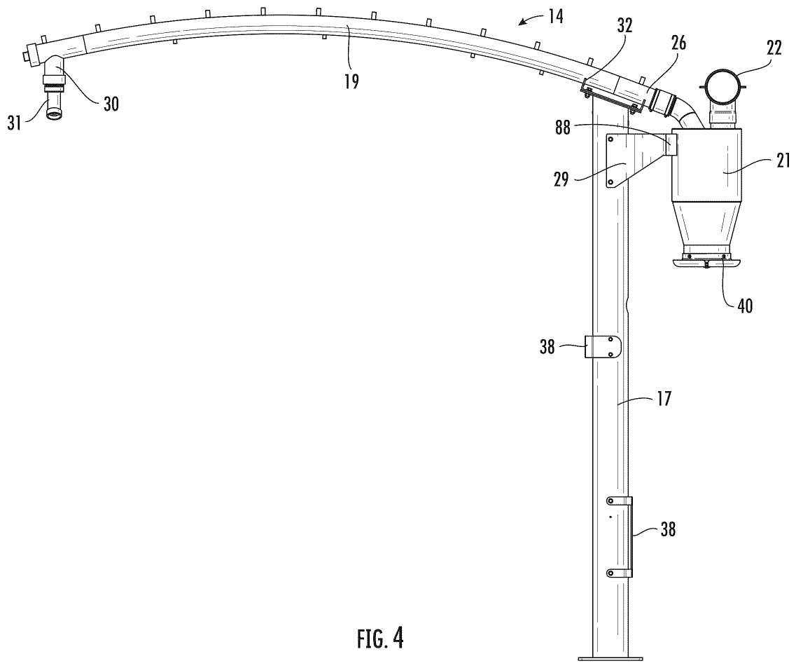

In a first adjustable configuration of the vehicle arch system (FIGS. 5-9), the separator 21 is engaged to the arch 19 proximate to the arch's first end 24. In this configuration, the separator 21 is engaged with the downwardly facing inlet pipe via its air discharge pipe that is located on top of the separator 21. In effect, the separator 21 hangs below the first end 24 of the arch 19 and above the vacuum stalls around it. Because it is more efficient for a single vacuum arch system 14 to have two user operated vacuuming lines 18 to service one or two adjacent vacuum stalls, it is preferred that the separator 21 have two air inlets. A user operated vacuuming line 18 may be attached to both of the inlets and hang down from the arch 19 as they would in other vacuum arch systems 14. Air travels from the user operated vacuuming line 18, through the separator, through the arch suction line, and then into the tee junction and main vacuum line 20. The debris are captured by the separator 21 before they reach the suction line of the arch 19. Debris may get sucked all of the way back to the vacuum motor, or it may instead build up within the vacuum line and need to be removed. With the separator located upstream from the suction providing arch line, clogs are prevented within the arch itself. Beyond simple clogging protection, if there are less debris travelling through the arch suction line, there will be less overall wear and tear. Less wear and tear mean the arch suction line does not need maintenance as often. This results in a dramatic decrease in operating costs for the overall vehicle treatment facility. Because the arch suction providing line is typically housed within the arch 19, it is difficult to replace since the arch will need to be opened up. Additionally, the arch If the arch 19 were to become plugged, two vacuum stalls would be inoperable as opposed to just one. The downwardly extending inlet pipe may vary in length so that the separator 21 is at different heights according to the needs of the vehicle wash facility.

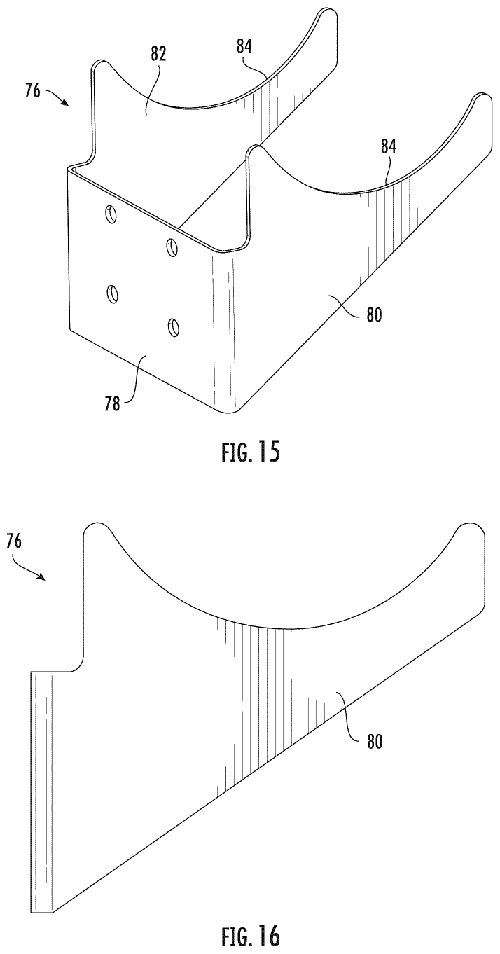

In the first adjustable configuration, the vehicle arch system includes a sanitary tee support bracket 76 (FIGS. 14-16). The sanitary tee support bracket 76 is engaged with the rear bracket and helps secure the sanitary tee to the vertical support pole 17. The sanitary tee support bracket 76 comprises a sanitary tee support base section 78 having an upper edge, lower edge, right edge, and left edge, as well as a right side sanitary tee grip 80 and a left side sanitary tee grip 82. The left side sanitary tee grip 82 is engaged with the left edge and the right side sanitary tee grip 80 is engaged with the right edge. The right side and left side sanitary tee grips are set at a 90 degree angle relative to the sanitary tee support base. Both the right and left side sanitary tee grips include a U-shaped tee engaging edge 84, that is shaped to matingly engage the outer surface of the sanitary tee. The sanitary tee base section includes a plurality of through holes spaced apart from one another, where the plurality of through holes corresponds to the number and location of slots in the grip brackets 44 of the rear support brackets. A fastener is secured within the through holes and the slot. A user may slide a bolt into either the through hole or the slot until the head catches on the exterior surface of either bracket. A threaded extended member of the bolt passes through the slot and the through hole. On the opposing side of the brackets as the head, a user may place a washer and screw on the nut, thus securing the fastener and the brackets together.

With the separator 21 in the front, the vacuum arch system overall is more efficient. As airflow is forced by twists and turns, the friction builds up and reduces the pressure within the air lines. With a cyclonic separator in the front, the air will only need to make a turn at the intersection of the downwards facing pipe and the suction providing airflow line within the arch, as well as in the tee junction at the second end of the arch 19. The airflow is much more direct and smoother, allowing the pressure to be maintained throughout the vacuum lines. With the sanitary tee junction being directly connected to the second end of the arch 19, there is no need for an intermediate connection pipe or conduit. Instead, air flows from the internal suction providing airflow line and into the sanitary tee junction. There are less components required by the system and it will be easier to repair. The separator may also be disconnected from the arch 19 without disconnecting the vacuum arch system 14 from the main vacuum line. If the separator is not functioning correctly, only it needs to be removed, and the only exposed section of the airflow line will be the downwards facing pipe 30. With the separator is attached to the second end of the arch, then the sanitary tee junction as well as an airflow connection pie, originally for connecting the separator to the second end, will be open and exposed.

In a second adjustable configuration of the vehicle arch system (FIGS. 2-5), the cyclonic debris separator is engaged to the arch 19 proximate to the arch's second end 26, which is rearward. The cyclonic debris separator is held up by the left and right support brackets 28, 29 and has an airflow connection pipe 86 connecting an inlet of the separator to the second end 26 of the arch 19 so that air may flow from the arch 19 into the cyclonic debris separator. For this configuration, while two may be used, typically only a single air inlet is needed in the cyclonic debris separator as the user operated vacuum lines of the vacuum arch system 14 will only be attached to the arch 19. The sanitary tee is engaged to the air discharge pipe by its filter end 74 and is oriented with the filter pointed down to the cyclonic debris separator and the first and second ends in a horizontal position. The downwardly facing inlet pipe includes a Y junction, a tee junction, or any pipe connection with too inlets and an outlet so that each inlet may be engaged to a user operated vacuuming line 18 and the outlet may be engaged to the downwardly facing inlet pipe. In alternative embodiments, there is only a single user operated vacuuming line 18 that is directly connected to the downwardly facing inlet pipe. In this configuration, air flows from the user operated vacuuming line 18, through the downwardly facing inlet pipe, through the arch 19, through the airflow connection pipe 86, into the cyclonic debris separator wherein debris are captured, and then into and through the sanitary tee and into the main vacuum line 20.

The airflow connection pipe is a rigid pipe that extends from the inlet of the separator to the second end 26 of the arch 19. It may have a curved shape. The airflow connection pipe may also be integral with the internal suction providing airflow line. In this case, the entire internal suction providing airflow line would need to be inserted into the arch 19 from the second end and slid forward until the integral airflow connection pipe lines up with the inlet on the separator. In other cases, the airflow connection pipe is a flexible airflow conduit, which may be positioned as desired by a vehicle wash facility.

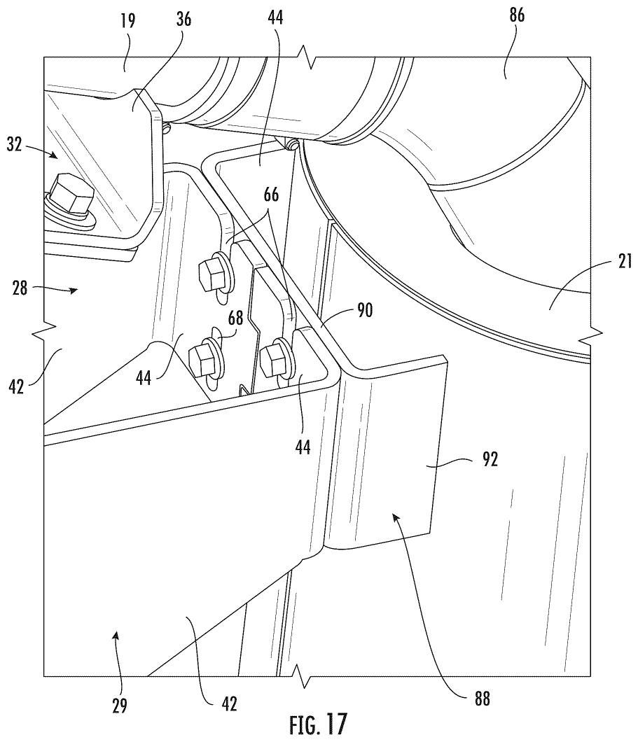

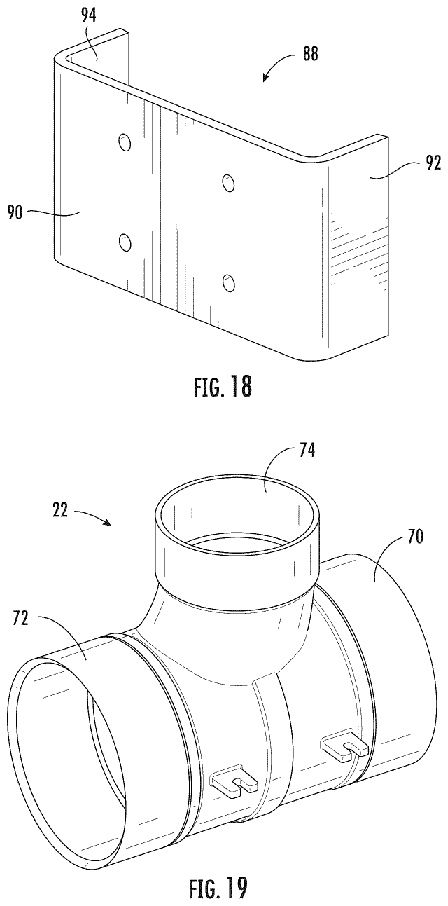

In the second adjustable configuration, the vehicle arch system includes a separator support bracket 88 as shown in FIGS. 17 and 18, although it may use a filter separator or other debris separator. The separator support bracket 88 is engaged to the rear bracket and helps secure the separator 21 to the vertical support pole 17. The separator support bracket 88 incudes a base portion 90 having a right edge and a left edge. A right side separator grip 92 is engaged to the right edge and a left side separator grip 94 is engaged to the left edge. Both the right side and left side separator grips are set at a right angle with the base portion 90, and extend towards the cyclonic debris separator. The cyclonic debris separator is typically welded to the right side and left side separator grips, but they may instead be attached with one or a plurality of fasteners and/or adhesives. The fasteners used are most preferably tapping screws. The base portion 90 typically has a plurality of fastener through holes that correspond with the number of slots on the rear support bracket. The grip brackets 44 of the right support bracket 29 and the left support bracket 28 meet and contact a first surface of the base portion 90. The right and left side separator grips extend outwards in the direction of a second surface of the base portion 90 that is opposite to the first surface.

What is claimed is:

1. A vacuum arch system located at an overall vehicle treatment facility for providing suction to a user operated vacuuming line used by a user of the overall vehicle treatment facility to clean an inside of a vehicle of the user, the vacuum arch system comprising:
a vertical support pole having a top end and a bottom end;
an arch arm attached to the top end portion of, and extending laterally away from, the vertical support pole and having a first end with a downwardly facing inlet pipe, and a second end proximate to the vertical support pole;
a rear facing bracket; and
a vacuum line debris separator that is operably and interchangeably engaged to either of the following without removing the rear facing bracket:
a) the downwardly facing inlet pipe, and wherein the second end of the arch arm is engaged with a main vacuum line via a tee junction and the vacuum line debris separator is engaged with an at least one user operated vacuuming line, and wherein the rear facing bracket supports and engages the tee junction; or
b) the second end of the arch arm, wherein the downwardly facing inlet pipe is engaged with the at least one user operated vacuuming line and the vacuum line debris separator is engaged to the main vacuum line, and wherein the rear facing bracket supports the vacuum line debris separator.

2. The vacuum arch system of claim 1, wherein the rear facing bracket comprises:
a right side rear facing bracket comprising of a right side pole engaging portion and a right side grip bracket and wherein the right side rear facing bracket is engaged to the vertical support pole proximate at a top end portion of the vertical support pole by the right side pole engaging portion;
a left side rear facing bracket comprising of a left side pole engaging portion and a left side grip bracket and wherein the left side rear facing bracket is engaged to the vertical support pole proximate to the top end portion of the vertical support pole by the left side pole engaging portion; and
wherein the left side grip bracket and the right side grip bracket matingly engages the rear facing bracket.

3. The vacuum arch system of claim 2, wherein the right side rear facing bracket comprises a right pole engaging section and a right mounting section, and wherein the right pole engaging section and the right mounting section are set at a 90 degree angle with one another, and wherein the left side rear facing bracket comprises a left pole engaging section and a left mounting section, wherein the left pole engaging section and the left mounting section are set at a 90 degree angle from one another, and wherein the left pole engaging section and the right pole engaging section are both affixed to the vertical support pole at the same height.

4. The vacuum arch system of claim 1, wherein the tee junction comprises an upstream end, a downstream end, and an arch system engaging end, wherein the arch system engaging end is operably engaged to either:
a) the vacuum line debris separator if the vacuum line debris separator is connected to the second end of the arch arm; or
b) The second end of the arch arm if the vacuum line debris separator is engaged to the downwardly facing inlet pipe.

5. The vacuum arch system of claim 2, wherein the right side rear facing bracket and the left side rear facing bracket are secured to the vertical support pole with tapping screws;
and wherein when the vacuum line debris separator is operably engaged to the downwardly facing inlet pipe, the vacuum line debris separator has a plurality of air inlets and the at least one user operated vacuuming line is a plurality of user operated vacuuming lines that are engaged with the plurality of air inlets.

6. The vacuum arch system of claim 1 further comprising an arch holding bracket connected to a top end of the vertical support pole and set at an acute angle in relation to the ground, and wherein the arch holding bracket comprises a flat base section, and a first grip and a second grip that both engage an underside of the arch arm proximate the second end, and wherein the arch arm is secured to the arch holding bracket.

7. The vacuum arch system of claim 6, wherein the arch holding bracket further comprises a first edge and a second edge opposite the first edge on the flat base section, and wherein the first grip upwardly extends from the first edge and the second grip upwardly extends from the second edge, and wherein the arch arm is spaced within the first grip and the second grip.

8. A vacuum arch system located at an overall vehicle treatment facility for providing suction to a user operated vacuuming line used by a user of the overall vehicle treatment facility to clean an inside of a vehicle of the user, wherein the user operated vacuuming line is engaged to a main vacuum line of the overall vehicle treatment facility, the vacuum arch system comprising:
a vertical support pole having a top end and a bottom end, wherein the bottom end is secured to the ground;
an arch arm attached to the top end of, and extending from, the vertical support pole and having a first end with a downwardly facing inlet pipe, and an open second end proximate to the vertical support pole;
at least one user operated vacuuming line;
a right side rear facing bracket comprising of a right side pole engaging portion and a right side grip bracket and that is engaged to the vertical support pole proximate to the top end by the right side pole engaging portion;
a left side rear facing bracket comprising of a left side pole engaging portion and a left side grip bracket and that is engaged to the vertical support pole proximate to the top end by the left side pole engaging portion;
wherein the left side grip bracket and the right side grip bracket matingly engage and the right side rear facing bracket and the left side rear facing bracket form an overall rear side bracket; and
a separator that is operably engaged to the downwardly facing inlet pipe, and wherein the open second end of the arch arm is engaged with a main vacuum line via a tee junction and the separator is engaged with the at least one user operated vacuuming line, and wherein the overall rear side bracket supports the tee junction.

9. The vacuum arch system of claim 8, wherein the tee junction comprises an upstream end, a downstream end, and arch connecting end, wherein the arch connecting end is operably engaged with the open second end of the arch arm and the upstream end and the downstream end are engaged with the main vacuum line.

10. The vacuum arch system of claim 8, wherein the right side rear facing bracket and the left side rear facing bracket are secured to the vertical support pole with tapping screws, and wherein the right side rear facing bracket and the left side rear facing bracket both further comprise one or more elongated fastener receiving slots proximate a rear facing side of the right side rear facing bracket and a left side rear facing bracket.

11. The vacuum arch system of claim 8, wherein the separator has a plurality of air inlets and the at least one user operated vacuuming line is a plurality of user operated vacuuming lines that are engaged with the plurality of air inlets.

12. The vacuum arch system of claim 11, wherein the right side rear facing bracket and the left side rear facing bracket are secured to the vertical support pole with tapping screws;
and wherein either the right side rear facing bracket has a locking slot and the left side rear facing bracket has an extension sized to matingly engage the locking slot of the right side rear facing bracket or the right side rear facing bracket has an extension sized to matingly engage a locking slot of the left side rear facing bracket and the left side rear facing bracket has the locking slot.

13. The vacuum arch system of claim 8 further comprising a tee junction support bracket that comprises a bracket connecting base that is engaged to the right side rear facing bracket and the left side rear facing bracket and at least one tee junction connecting arm that is engaged to the tee junction.

14. A vacuum arch system located at an overall vehicle treatment facility for providing suction to a user operated vacuuming line used by a user of the overall vehicle treatment facility to clean an inside of a vehicle of the user, wherein the user operated vacuuming line is engaged to a main vacuum line of the overall vehicle treatment facility, the vacuum arch system comprising:
a vertical support pole having a top end and a bottom end, wherein the bottom end is secured to the ground;
an arch arm attached to the top end of, and extending from, the vertical support pole and having a first end with a downwardly facing inlet pipe, and an open second end proximate to the vertical support pole;
at least one user operated vacuuming line;
a right side rear facing bracket comprising of a right side pole engaging portion and a right side grip bracket and that is engaged to the vertical support pole proximate to the top end by the right side pole engaging portion;
a left side rear facing bracket comprising of a left side pole engaging portion and a left side grip bracket and that is engaged to the vertical support pole proximate to the top end by the left side pole engaging portion;
wherein the left side grip bracket and the right side grip bracket matingly engage and the right side rear facing bracket and the left side rear facing bracket form an overall rear side bracket; and
a separator that is operably engaged to the open second end of the arch arm, wherein the downwardly facing inlet pipe is engaged with the at least one user operated vacuuming line and the separator is an engaged to the main vacuum line, and wherein the overall rear side bracket supports the separator.

15. The vacuum arch system of claim 14 further comprising a tee junction that comprises an upstream end, a downstream end, and a separator connecting end, wherein the separator connecting end is operably engaged with the separator, and the upstream end and the downstream end are engaged to the main vacuum line.

16. The vacuum arch system of claim 15, wherein the right side rear facing bracket and the left side rear facing bracket are secured to the vertical support pole with tapping screws; and wherein either the right side rear facing bracket has a locking slot and the left side rear facing bracket has an extension sized to matingly engage the locking slot of the right side rear facing bracket or the right side rear facing bracket has an extension sized to matingly engage a locking slot of the left side rear facing bracket and the left side rear facing bracket has the locking slot.

17. The vacuum arch system of claim 14 further comprising a separator support bracket that comprises a bracket connecting base that is engaged to the right side rear facing bracket and the left side rear facing bracket and at least one separator connecting arm that is engaged to the separator.

18. The vacuum arch system of claim 15 further comprising a separator support bracket that comprises a bracket connecting base that is engaged to the right side rear facing bracket and the left side rear facing bracket and at least one separator connecting arm that is engaged to the separator.

19. The vacuum arch system of claim 14, wherein the right side rear facing bracket and the left side rear facing bracket are secured to the vertical support pole with tapping screws, and wherein the right side rear facing bracket and the left side rear facing bracket both further comprise one or more elongated fastener receiving slots proximate a rear facing side of the right side rear facing bracket and a left side rear facing bracket.

20. The vacuum arch system of claim 14 further comprising an arch holding bracket engaged to the top end of the vertical support pole and set at an acute angle in relation to the ground, and wherein the arch holding bracket comprises a flat base section having a first edge, a second edge opposite from the first edge, a first grip engaged to and extending upwards from the first edge, a second grip engaged to an extending upwardly from the second edge, and wherein the arch arm is secured to the vertical support pole by the first grip and the second grip of the arch holding bracket.
